(19) United States
(12) Patent Application Publication
(10) Pub. No.: US 2026/0054209 A1
(43) Pub. Date: Feb. 26, 2026

(54) Method for Purifying Dust-containing Gas with Positive Pressure

(71) Applicant: Suzhou University of Science and Technology, Suzhou (CN)

(72) Inventors: Xing ZHANG, Suzhou (CN); Yubin CHI, Suzhou (CN); Zhigang WANG, Suzhou (CN); Wenjian TAO, Suzhou (CN)

(73) Assignee: Suzhou University of Science and Technology, Suzhou (CN)

(21) Appl. No.: 19/377,022

(22) Filed: Nov. 2, 2025

Related U.S. Application Data
(63) Continuation of application No. PCT/CN2024/093635, filed on May 16, 2024.

(51) Int. Cl. B01D 50/20; B01D 45/08; B01D 45/16; B01D 45/18; B01D 46/24; B01D 46/48; B04C 5/02; B04C 5/185; B04C 9/00

(52) U.S. Cl. CPC B01D 50/20; B01D 45/08; B01D 45/16; B01D 45/18; B01D 46/2403; B01D 46/48; B04C 5/02; B04C 5/185; B04C 9/00; B01D 2267/30; B01D 2267/60; B04C 2009/002

(57) ABSTRACT

A method for purifying dust-containing gas with positive pressure, which relates to the field of air pollution control technology, includes: transporting the dust-containing gas into a cyclone device by the positive pressure; removing at least a portion of dust from the dust-containing gas by a centrifugal cyclone part of the cyclone device; entering into a settling chamber, for the dust-containing gas which has been purified in the cyclone device, wherein at least a portion of dust is settled down in the settling chamber with collision under an action of inertial force carried by the dust-containing gas; and proceeding to enter and purify in a purifying chamber, for the dust-containing gas which has been settled down in the settling chamber, wherein a purified gas flows out from an outlet of the purifying chamber.

### CROSS-REFERENCE TO RELATED APPLICATION

This application is a continuation of International Patent Application No. PCT/CN2024/093635 filed on May 16, 2024, the disclosure of which is hereby incorporated by reference in its entirety.

### BACKGROUND

In daily life, harmful substances such as dust, particles, dust particles, lint, which are typically contained in the air, are important pollution sources of affecting air quality; similarly, in the production field, harmful substances such as dust of powder and lint dust in the gas also affect the safety of the production environment. It is necessary to improve gas purification and dust removal methods for reducing the impact of the above-mentioned harmful substances. Currently, one of the effective ways to purify air and reduce pollution in the production and living fields is to install the gas dust removal equipment in pollution sites. By the gas dust removal equipment, reducing or even eliminating dust, large particles, dust particles, lint and other pollutants in the air or gas can effectively reduce their harm to the health of workers and residents.

However, the methods for purifying gas, which are adopted by the existing gas dust removal equipment, are mostly the dust removal mode with negative pressure. It is generally believed that the advantages of the dust removal with negative pressure are over the dust removal with positive pressure: higher dust removal efficiency and stable dust removal effect. At the same time, it cannot be ignored that due to the inherent characteristics of the negative pressure dust removal, when the dust-containing gas enters the gas dust removal equipment, if there are deficiencies in the channel design or uneven internal airflow distribution in the gas dust removal equipment itself, it is possible to lead to decrease in dust removal efficiency. The dust removal method with positive pressure can still be used in some production processes in applications, such as in scenarios with a higher proportion of particles or lint carried by the airflow, there is a significant market demand for the gas purification equipment using the purification and dust removal method with positive pressure.

At the same time, it should also be noted that mainstream dust removal methods with positive pressure are easily prone to issues such as rapid aging of equipment, poor sealing, and imbalanced pressure control, therefore, when dealing with gases containing dust explosion risk, such as metal powder dust, the above-mentioned issues may pose amplified safety risks.

Therefore, there is an urgent need for a new method for purifying dust-containing gas with positive pressure which adjusts the layout of the flow passages and improves the airflow distribution inside the dust removal equipment, thereby increasing the dust removal efficiency.

### SUMMARY

In order to solve or partially solve issues in some implementations described above, the aim of the disclosure is to provide a method for purifying dust-containing gas with positive pressure, which adopts a positive pressure air supply mode, improves the airflow distribution within an equipment for purifying dust-containing gas with positive pressure and increases the dust removal efficiency.

The disclosure of this application relates to the field of air pollution control technology, and in particular to a method for purifying dust-containing gas with positive pressure.

According to one aspect of the disclosure, a method for purifying dust-containing gas with positive pressure is provided, wherein the method includes steps as follows:
transporting the dust-containing gas into a cyclone device by the positive pressure;
removing at least a portion of dust from the dust-containing gas by a centrifugal cyclone part of the cyclone device;
entering into a settling chamber, for the dust-containing gas which has been purified in the cyclone device, wherein at least a portion of dust is settled down in the settling chamber with collision under an action of inertial force carried by the dust-containing gas; and
proceeding to enter and purify in a purifying chamber, for the dust-containing gas which has been settled down in the settling chamber, wherein a purified gas flows out from an outlet of the purifying chamber.

According to an embodiment of the method, the cyclone device, the settling chamber and the purifying chamber are sequentially communicated with each other in series, so as to make the dust-containing gas pass through them in sequence. At least a portion of dust is removed from the dust-containing gas when it passes through the cyclone device; furthermore, the dust-containing gas passes through the settling chamber and the purifying chamber, similarly, at least a portion of dust is removed from the dust-containing gas. The dust-containing gas passes through the cyclone device, the settling chamber and the purifying chamber in sequence, the dust in the dust-containing gas gradually decreases, and the purifying degree of the dust-containing gas gradually increases.

According to an embodiment of the method, a tilted deflector plate is disposed at a gas inlet of the cyclone device, a tilt angle of the tilted deflector plate is set to be the same as a lead angle of a helical line of a helical face of the centrifugal cyclone part. The dust-containing gas enters the cyclone device along the tilted deflector plate and continues to flow along the helical face, because the tilt angle of the tilted deflector plate is the same as the lead angle of the helical line of the helical face, an airflow distribution of the dust-containing gas becomes more even, which avoids reentrainment of dusting and is beneficial for settlement of the dust, lint, particles and the like.

According to an embodiment of the method, a connection pipe is disposed between the cyclone device and the settling chamber, wherein an overall cross-section area of a connecting port of the connection pipe with the cyclone device is in size smaller than an overall cross-section area of a connecting port of the connection pipe with a gas inlet end of the settling chamber. In the process of the dust-containing gas discharging from the cyclone device into the settling chamber through the connection pipe, the cross-section area gradually increases, the airflow velocity of the dust-containing gas decreases, avoiding that the airflow velocity of the dust-containing gas entering the settling chamber from the cyclone device is excessively high to lead the dust and lint to fly around.

According to an embodiment of the method, the gas inlet end communicated to the cyclone device is provided at one side of the settling chamber, wherein the dust-containing gas purified by the cyclone device enters the settling chamber via the gas inlet end, and the gas inlet end is located at a position of a ⅔ height of a total height of the one side of the settling chamber.

According to an embodiment of the method, a baffle plate is set at an opposite side of the gas inlet end of the settling chamber, so that the dust-containing gas enters the settling chamber via the gas inlet end, and collides with the baffle plate, so that an airflow direction of the dust-containing gas is abruptly changed, and at least a portion of dust is separated from the dust-containing gas under an action of inertial force carried by the dust-containing gas.

According to an embodiment of the method, a gas outlet end is formed at a gap which is located between the baffle plate and a bottom of the settling chamber, the settled dust-containing gas in the settling chamber enters the purifying chamber via the gas outlet end to be purified, wherein the gas inlet end is arranged to be central symmetry with respect to the gas outlet end. The dust-containing gas is introduced into the settling chamber from the gas inlet end, and an overall flow direction of the dust-containing gas is from top to bottom in the settling chamber. Since the gas inlet end is set at the position of the ⅔ height of the total height of the one side of the settling chamber, and the gas outlet end is located between the opposite baffle plate of the settling chamber and the bottom of the settling chamber with respect to the gas inlet end, wherein an airflow path of the dust-containing gas is longest in the settling chamber, and the effect of dust settling by the gravity is optimal.

According to an embodiment of the method, a cross-section area of the gas outlet end is set to be 2-4 times as large as a cross-section area of a lower end of the settling chamber, the lower end of the settling chamber is the connection part between the settling chamber and the collection and extrusion device, so that the dust-containing gas undergoes reduction of an airflow velocity so as to be settled down after the dust-containing gas enters the purifying chamber; and a filter cylinder assembly in the purifying chamber is used to filter the dust-containing gas entered therein.

Further, according to an embodiment of the method, a collection and extrusion device is arranged at a lower end of at least one of the cyclone device, the settling chamber and the purifying chamber, to extrude and recycle the dust collected therein.

According to another development of the method, a conical outlet is disposed at an end of the collection and extrusion device, wherein the dust which is collected in the collection and extrusion device is extruded by the conical outlet, and the dust is prevented from crossflowing by blades of the collection and extrusion device.

The method for purifying dust-containing gas with positive pressure in accordance with the embodiments of the disclosure has at least one of the following advantages or a part of one advantage thereof:
(1) the air supply mode with positive pressure is adopted, instead of using the air supply mode with negative pressure, in order to improve the airflow distribution within the dust removal equipment and increase the efficiency of dust removal;
(2) the dust-containing gas passes through the cyclone device, the settling chamber and the purifying chamber in sequence, wherein the dust of the dust-containing gas is sequentially decreased, and the purifying degree of the dust-containing gas is gradually increased;
(3) the tilted deflector plate is disposed at a lower edge of the gas inlet of the cyclone device, and the tilt angle of the tilted deflector plate is the same as the lead angle of the helical line of the helical face of the centrifugal cyclone part, which avoids reentrainment of dust, and the more even distribution of the interior airflow is beneficial for the settling of the dust and lint;
(4) after discharging of the dust-containing gas from the cyclone device, during introducing the dust-containing gas into the settling chamber via the connection pipe, the cross-section area gradually increases, and the flow velocity of the dust-containing gas is reduced, so as to avoid the flow velocity of the dust-containing gas discharged from the cyclone device and entering the settling chamber too large, thereby leading to the flying of the dust and lint;
(5) by setting the gas inlet end at the position of the ⅔ height of the total height of the one side of the settling chamber, and disposing the baffle plate at the opposite side of the gas inlet end, the dust-containing gas collides with the baffle plate after entering the settling chamber, and the airflow direction of the dust-containing gas is abruptly changed, at least a portion of dust is separated from the dust-containing gas under the action of inertial force carried by the dust-containing gas, which achieves the effect of partial dust removal;
(6) the dust-containing gas enters the settling chamber from the gas inlet end, the overall flow direction of the dust-containing gas is from top to bottom in the settling chamber, since the gas inlet end is set at the position of the ⅔ height of the total height of the one side of the settling chamber, and the gas outlet end, which is central symmetry with respect to the gas inlet end, is provided between the opposite baffle plate of the settling chamber and the bottom of the settling chamber, wherein the airflow path of the dust-containing gas in the settling chamber is longest, and the settling effect of dust by the gravity is optimal;
(7) the cross-section area of the gas outlet end is 2-4 times as large as the cross-section area of the lower end of the settling chamber, so that the dust-containing gas undergoes reduction of the flow velocity to be settled down after the dust-containing gas entering the purifying chamber, which is beneficial for separating the dust from the dust-containing gas.

It should be understood that the above general description and the detailed descriptions below are exemplary and explanatory only and do not limit the disclosure.

### BRIEF DESCRIPTION OF THE DRAWINGS

These and/or other aspects and advantages of the disclosure will be more apparent and understandable from the description of the embodiments of the disclosure in conjunction with the drawings.

FIG. 1 is a schematic diagram of a flowchart for a method for purifying dust-containing gas with positive pressure in accordance with an embodiment of the disclosure;

FIG. 2 is a schematic structural perspective view of an equipment for purifying dust-containing gas with positive pressure in accordance with an embodiment of the disclosure;

FIG. 3 is a schematical cross-sectional view of a structure of the equipment for purifying dust-containing gas with positive pressure as shown in FIG. 2;

FIG. 4 is a schematic structural view of a tilted deflector plate which is disposed at a gas inlet of a cyclone device as shown in FIG. 3;

FIG. 5 is a schematic structural view of a settling chamber as shown in FIG. 3;

FIG. 6 is a schematic structural view of a baffle plate and a gas outlet end of the settling chamber as shown in FIG. 5;

FIG. 7 is a schematic structural view of a purifying chamber as shown in FIG. 3;

FIG. 8 is a partially enlarged view of the purifying chamber as shown in FIG. 3;

FIG. 9 is a schematical front view of a structure of another equipment for purifying dust-containing gas with positive pressure in accordance with an embodiment of the disclosure;

FIG. 10 is a schematic structural perspective view of an equipment for purifying dust-containing gas with positive pressure which has a collection and extrusion device in accordance with an embodiment of the disclosure;

FIG. 11 is a schematical cross-sectional view of a structure of the equipment for purifying dust-containing gas with positive pressure which has the collection and extrusion device as shown in FIG. 10; and

FIG. 12 is a schematic structural view of the collection and extrusion device as shown in FIG. 10.

### DETAILED DESCRIPTION

Hereinafter, the features of the disclosure will be further described by specific embodiments. The description of the embodiments of the disclosure with reference to the accompanying drawings intends to explain the general inventive concept of the disclosure and should not be understood as a limitation to the disclosure.

In embodiments of the disclosure, a method for purifying dust-containing gas with positive pressure is provided. The method achieves the purpose of increasing the efficiency of dust removal, by improving airflow distribution within an equipment for purifying dust-containing gas with positive pressure, which transports the dust-containing gas into a cyclone device, a settling chamber and a purifying chamber in turn, wherein the dust is removed step by step from the dust-containing gas, and the purified gas flows out from an outlet of the purifying chamber.

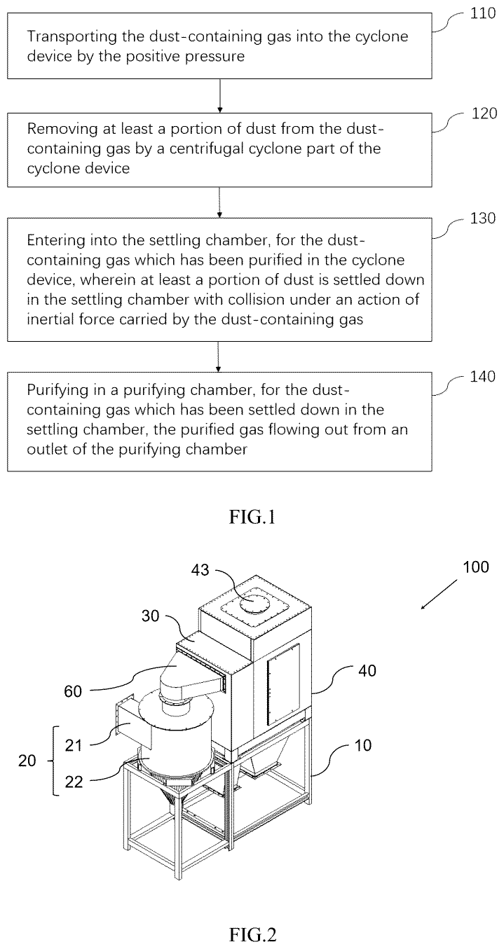

Specifically, as shown in FIG. 1, the method for purifying dust-containing gas with positive pressure in accordance with the embodiment of the disclosure includes steps as follows:
110, transporting the dust-containing gas into a cyclone device by the positive pressure;
120, removing at least a portion of dust from the dust-containing gas by a centrifugal cyclone part of the cyclone device;
130, entering into a settling chamber, for the dust-containing gas which has been purified in the cyclone device, wherein at least a portion of dust is settled down in the settling chamber with collision under an action of inertial force carried by the dust-containing gas; and
140, proceeding to introduce and purify in a purifying chamber, for the dust-containing gas which has been settled down in the settling chamber, wherein a purified gas flows out from an outlet of the purifying chamber.

The method for purifying dust-containing gas with positive pressure is achieved by an equipment for purifying dust-containing gas with positive pressure. Specifically, referring to FIG. 2, it is a schematic structural perspective view of the equipment for purifying dust-containing gas with positive pressure in accordance with an embodiment of the disclosure. As shown in FIG. 2, the equipment for purifying dust-containing gas with positive pressure includes four main parts: a frame 10, a cyclone device 20, a settling chamber 30 and a purifying chamber 40. The positive pressure is provided for the dust-containing gas by an external air supply device, so that the dust-containing gas with positive pressure enters the equipment 100 for purifying dust-containing gas with positive pressure, which can be understood that the dust-containing gas is delivered into the cyclone device 20 by the external air supply device.

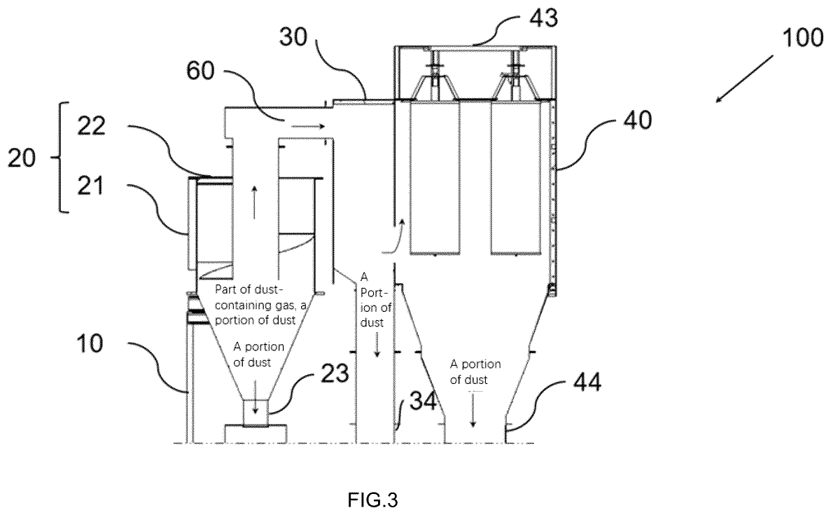

Specifically, referring to FIG. 3, others main parts of the equipment 100 for purifying dust-containing gas with positive pressure are supported by the frame 10. The dust-containing gas with positive pressure enters the cyclone device 20 via a gas inlet 21, at least a portion of dust of the dust-containing gas is separated from the dust-containing gas under the action of a centrifugal force generated when the dust-containing gas flows through the cyclone device 20. The dust-containing gas purified in the cyclone device 20 then enters the settling chamber 30, wherein at least a portion of dust of the dust-containing gas is settled down therein with the collision under the action of inertial force carried by the dust-containing gas. The dust-containing gas purified in the settling chamber enters the purifying chamber 40 to be further purified, and the purified gas flows out from an outlet 43 of the purifying chamber 40. By the organic combination of the three dust removing devices consisting of the cyclone device 20, the settling chamber 30 and the purifying chamber 40, an airflow fluctuation is suppressed and an issue of low purifying efficiency caused by it can be effectively overcome, a stability of the dust removing operation can be improved, and further a dust removing efficiency of the equipment 100 for purifying dust-containing gas with positive pressure is raised. Herein, the specific description are made on each step as shown in FIG. 1.

In the step 110, said transporting the dust-containing gas into the cyclone device by the positive pressure further includes that a tilted deflector plate is disposed at the gas inlet of the cyclone device, and a tilt angle of the tilted deflector plate is the same as a lead angle of a helical line of a helical face of the centrifugal cyclone part of the cyclone device.

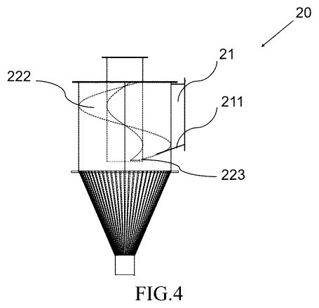

Exemplarily, referring to FIGS. 3 and 4, the cyclone device 20 includes the gas inlet 21 and the centrifugal cyclone part 22, the tilted deflector plate 211 is disposed at the gas inlet of the cyclone device 20, the tilt angle of the tilted deflector plate 211 is set to be the same as the lead angle of the helical line 223 of the helical face 222 of the centrifugal cyclone part 22. The dust-containing gas enters the cyclone device 20 along the tilted deflector plate 211, and then continues to flow along the helical face 222. Because the angle of the tilted deflector plate 211 is the same as the lead angle of the helical line 223 of the helical face 222, an airflow of the dust-containing gas is more evenly distributed, which is beneficial for settling the dust, the lint and the particles and the like while avoiding reentrainment of dust.

In the step 120, at least a portion of dust is removed from the dust-containing gas by the centrifugal cyclone part of the cyclone device.

Exemplarily, referring to FIG. 3, a gas inlet direction of the gas inlet 21 (i.e. a flow direction of the dust-containing gas) is perpendicular to a direction of a rotation axis of the centrifugal cyclone part 22. The dust-containing gas enters the cyclone device 20 via the gas inlet 21, and at least a portion of the dust in the dust-containing gas is removed by the centrifugal cyclone part 22 of the cyclone device 20 by the positive pressure carried by the dust-containing gas. In an example, the flow velocity of the gas at the gas inlet 21 is 3-6 m/s.

The step 130 further includes that a connection pipe is disposed between the cyclone device and the settling chamber, wherein an overall cross-section area of a connecting port of the connection pipe with the cyclone device is in size smaller than an overall cross-section area of a connecting port of the connection pipe with a gas inlet end of the settling chamber.

Furthermore, the gas inlet end which is communicated with the cyclone device, is provided at one side of the settling chamber, wherein the dust-containing gas purified by the cyclone device enters the settling chamber by the gas inlet end, and the gas inlet end is set at a position of a ⅔ height of a total height of the one side of the settling chamber.

Specifically, and exemplarily, referring to FIG. 3, the connection pipe 60 is disposed between the cyclone device 20 and the settling chamber 30, the dust-containing gas enters the settling chamber 30 from the one side of the settling chamber 30 through the connection pipe 60. In an alternative embodiment, in conjunction with FIG. 2, the overall cross-section area of the connecting port of the connection pipe 60 with the cyclone device 20 is in size smaller than the overall cross-section area of the connecting port of the connection pipe 60 with the gas inlet end 31 of the settling chamber 30, for example, the cross-section area of the connection pipe 60 on the side of the settling chamber 30 is larger than the cross-section area of the connection pipe 60 on the side of the cyclone device 20, as the cross-section area gradually increases, the flow velocity of the dust-containing gas through the connection pipe 60 gradually decreases, which is effective to reduce turbulence and is beneficial for further improving dust removal effect after the dust-containing gas entering the settling chamber 30.

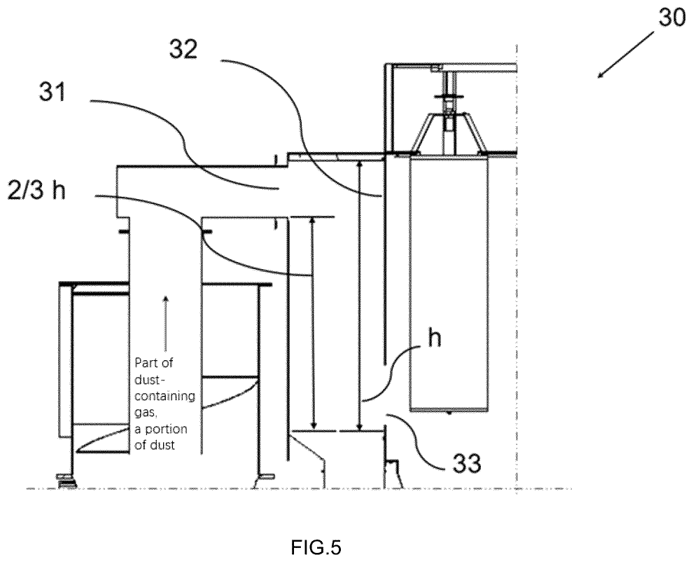

Please refer to FIG. 5, the settling chamber 30 is disposed to have a rectangular parallelepiped structure, and of course, it can also be disposed to have a structure of any other appropriate shape. The gas inlet end 31 is located at the one side of the settling chamber 30. Preferably, the gas inlet end 31 is set at the position of the ⅔h height of the total height h of the one side of the settling chamber 30. The dust-containing gas enters the settling chamber 30 through the gas inlet end 31, and exits from the settling chamber via a gas outlet end 33.

In one embodiment, the settling chamber 30 is also arranged with a baffle plate 32, which is located at an opposite side of the gas inlet end 31. For example, the baffle plate 32 is set at a top of the settling chamber 30 and is extended downward.

Furthermore, the step 130 further includes that a gas outlet end is formed at a gap which is located between the baffle plate and a bottom of the settling chamber, the settled dust-containing gas in the settling chamber enters the purifying chamber via the gas outlet end to be purified, wherein the gas inlet end is arranged to be central symmetry with respect to the gas outlet end.

Specifically, the gas outlet end 33 is formed by the gap which is located between the baffle plate 32 and the bottom of the settling chamber 30. As shown in FIG. 5, the gas outlet end 33 is set to be opposite to the gas inlet end 31 through the baffle plate 32, and the gas inlet end 31 is set to be central symmetry with respect to the gas outlet end 33. That is, the gas inlet end 31 is set at a top left corner of the settling chamber 30, while the gas outlet end 33 is set at a bottom right corner of the settling chamber 30. In this way, after entering into the settling chamber 30 from the gas inlet end 31, the dust-containing gas moves from top to bottom as a whole, and an airflow path of the dust-containing gas to the gas outlet end 33 is the longest, which is the optimal option in terms of the gravity settling and the flow path, and achieves the best settling effect.

In one embodiment, the flow velocity of the gas in the settling chamber 30 is 7-12 m/s.

It can be known from the simulation analysis of a flow field inside the settling chamber 30 that, after entering into the settling chamber 30 via the gas inlet end 31, the dust-containing gas collides with the baffle plate 32, the airflow direction changes abruptly, and at least a portion of the dust is separated from the dust-containing gas under the action of inertial force carried by the dust-containing gas.

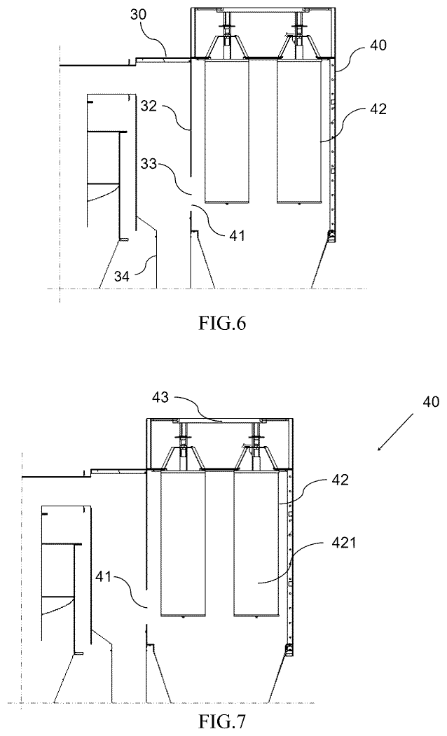

Referring to FIG. 6, a cross-section area of the gas outlet end 33 is set to be 2-4 times as large as a cross-section area of a lower end 34 of the settling chamber 30, preferably 3 times, and the lower end 34 of the settling chamber 30 is designed as a connection section between the settling chamber 30 and a collection and extrusion device 50. From the simulation analysis of the flow field between the purifying chamber 40 and the settling chamber 30, it can be known that when the dust-containing gas exits via the gas outlet end 33 and enters the purifying chamber 40, because the cross-section area of the gas outlet end 33 are 2-4 times as large as the cross-section area of the lower end 34 of the settling chamber 30, the airflow velocity of the dust-containing gas is decreased dramatically as the dust-containing gas passes through a filter cylinder assembly 42 of the purifying chamber 40, which further avoids dust particles and lint flying due to the excessive airflow velocity, and improves dust removal effect of the settling chamber.

The step 140 further includes that the filter cylinder assembly in the purifying chamber is used to filter the dust-containing gas therein.

Referring to FIG. 7, by way of example, the purifying chamber 40 includes three main parts, i.e. an inlet gas hole 41, the filter cylinder assembly 42 and an outlet 43, wherein inlet gas hole 41 can be the same one as the gas outlet end 33, or can be configured to be separate from the gas outlet end 33, as long as it is communicated with the gas outlet end 33. For example, two filter cylinder assemblies 42 can be set in the purifying chamber 40, which are disposed side by side at a top of the purifying chamber 40 and fixedly connected at an end of the purifying chamber 40 which is close to the outlet 43.

Specifically, each filter cylinder assembly 42 is disposed at an upper part of the purifying chamber 40, and is located in an inner region of the purifying chamber 40 between the outlet 43 and the inlet gas hole 41. Each filter cylinder assembly 42 also includes a filter cylinder 421, on which multiple filter holes are disposed so as to allow the dust-containing gas to pass through. When the dust-containing gas enters the purifying chamber 40, it passes through the filter cylinder assembly 42, and then exits from the purifying chamber 40 via the outlet 43.

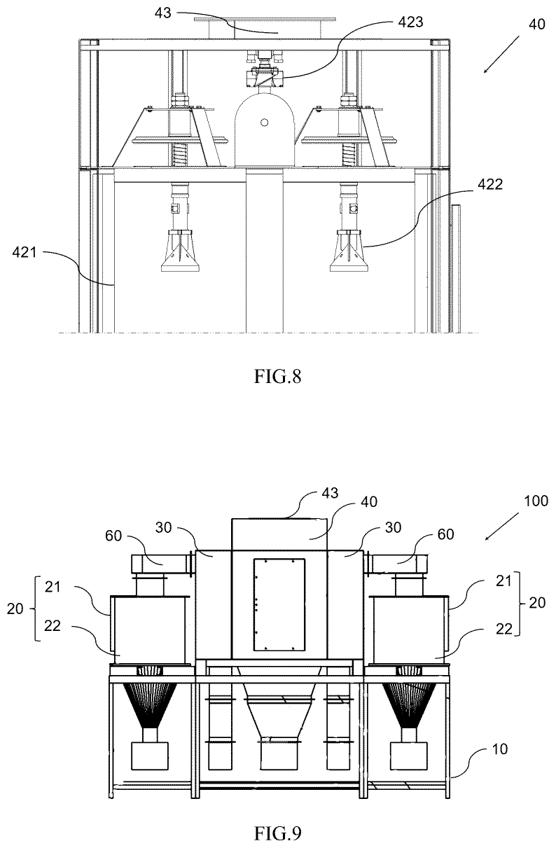

Referring to FIG. 8, furthermore, in an embodiment, the filter cylinder assembly 42 includes the filter cylinder 421, a pulse generator 422, a pulse valve 423, a gas tank and an electric control system. According to the practical working condition, the filter cylinder 421 of different specification can be selected, and a size of the gas tank can also be adjusted to save the cost.

When the dust-containing gas passes through the filter cylinder 421, at least a portion of the dust is blocked outside, and then the filtered gas passes the filter cylinder 421 and exits via the outlet 43; meanwhile, the gas tank contains compressed air, and the gas tank is connected with the pulse generator 422 by the pulse valve 423, the pulse valve 423 is automatically controlled to open or close by the electric control system based on the change of the pressure value inside the filter cylinder assembly 42 (referring to FIG. 7) detected by a pressure sensor. When the pulse valve 423 is opened, the compressed air in the gas tank is sprayed out by the pulse generator 422 from the gas tank through the pulse valve 423, and is sprayed into an interior of the filter cylinder 421 so as to clean the dust attached on the surface of the filter cylinder assembly 42.

In an alternative embodiment, the equipment 100 for purifying dust-containing gas with positive pressure can be disposed to introduce gas from one side or one end, and of course also can be disposed to introduce gas from both sides or two ends, or to introduce gas from multiple ends. Those skilled in the art can make a disposal as needed.

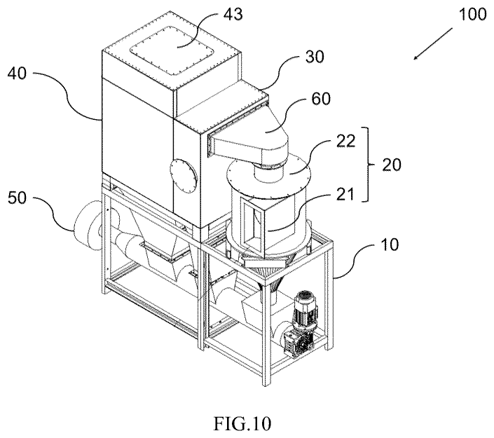

The explanation is made by taking a configuration of using two opposite ends to enter gas as an example. Specifically, referring to FIG. 9, both of the settling chambers 30 are disposed respectively on both sides of the purifying chamber 40, e.g. they are disposed symmetrically with respect to the middle of the purifying chamber 40; and the cyclone devices 20 are respectively disposed to communicate to the settling chamber 30 located at the same side, and one common purifying chamber 40 is disposed in the middle of the equipment 100 for purifying dust-containing gas with positive pressure. In this way, a spare space is sufficiently utilized and corresponding parts are omitted out, thereby increasing the dust removal efficiency.

The method for purifying dust-containing gas with positive pressure according to the disclosure further includes a step of extruding and recycling dust, which is achieved by the collection and extrusion device.

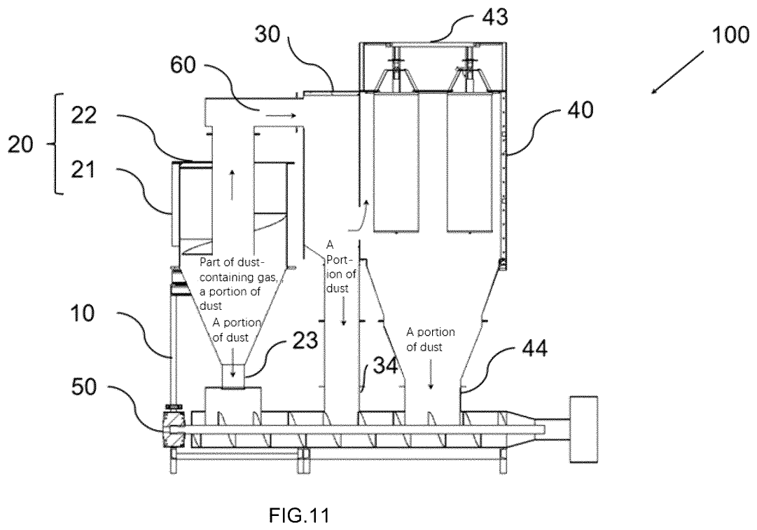

Specifically, referring to FIGS. 10 and 11, in an embodiment of the disclosure, the equipment for purifying dust-containing gas with positive pressure includes the collection and extrusion device 50. The lower ends of the cyclone device 20, the settling chamber 30 and the purifying chamber 40 are individually connected to the collection and extrusion device 50.

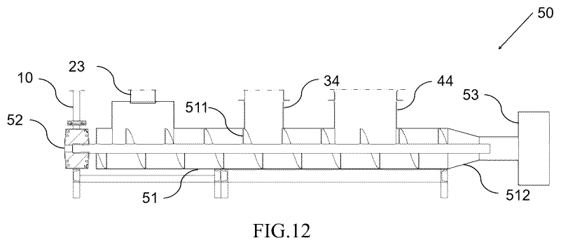

Specifically, referring to FIG. 12, the collection and extrusion device 50 includes three components: a housing 51, a drive part 52 and a collection part 53. The housing 51 has an elongated cylinder shape, and certainly can also have any other expected shape. The housing 51 is disposed at a lower end of the frame 10, and the lower end of at least one of the cyclone device 20, the settling chamber 30 and the purifying chamber 40 is connected to the housing 51.

Furthermore, in an embodiment, the housing 51 is connected to the lower end 23 of the cyclone device 20, at least a portion of dust of the dust-containing gas enters the housing 51 via the lower end 23; the housing 51 is connected to the lower end 34 of the settling chamber 30, at least a portion of dust of the dust-containing gas enters the housing 51 via the lower end 34; and the housing 51 is connected to the lower end 44 of the purifying chamber 40, at least a portion of dust of the dust-containing gas enters the housing 51 via the lower end 44.

In an embodiment, the housing 51 includes blades 511 therein, which are arranged in a longitudinal direction of the housing 51, and each have an outer edge abutting against the inner wall of the housing 511. The housing cooperates with the blades 511 to function as wind closing valve, to avoid the crossflow during a downstream transport process.

In an embodiment, the drive part 52 is disposed at an end of the housing 51 in the longitudinal direction thereof, and drives the blades 511 to rotate. The housing 51 has a conical outlet 512, which is located at the other end of the housing 51 in the longitudinal direction thereof. A cone bottom of the conical outlet 512 is connected to the housing 51, and a cone top of the conical outlet 512 is connected to the collection part 53. Under the push action when the blades 511 are driven by the drive part 52 to rotate, the dust is constantly accumulated toward the conical outlet 512, and finally is extruded at the conical outlet 512 and enters the collection part 53, which is helpful to reduce an occupied space for dust collection and to be more convenient for dust storage.

In operation, the dust is delivered out by rotation of the blades 511, and the conical outlet 512 is set to have a preset conical degree, e.g. 10-30 degrees, therefore the dust is extruded at this position. In this way, the space for dust collection is reduced, therefore the dust is stored after being extruded. Besides, the rotation of the blades 511 also plays a role of the wind closing valve, so that there is no crossflow during the downstream transport process.

### Embodiment 1

As mentioned above, in the method for purifying dust-containing gas with positive pressure, at first, with the positive pressure carried by the dust-containing gas, the dust-containing gas enters the cyclone device 20 along the tilted deflector plate 211 which is disposed at a lower edge of the gas inlet 21 of the cyclone device 20. The tilt angle of the tilted deflect plate 211 is set to the same as the lead angle of the helical line 223 of the helical face 222 of the centrifugal cyclone part 22. At least a portion of dust of the dust-containing gas is separated from the dust-containing gas by the centrifugal force which is generated as the dust-containing gas flows through the cyclone device 20, and is extruded and recycled by entering the collection and extrusion device 50 via the lower end 23 of the cyclone device 20, therefore the purified dust-containing gas is formed.

Furthermore, the dust-containing gas enters the settling chamber 30 from the one side of the settling chamber 30 via the connection pipe 60 of the cyclone device 20. The cross-section area of the connection pipe 60 on the side of the settling chamber 30 is larger than the cross-section area of the connection pipe 60 on the side of the cyclone device 20. The flow velocity of the dust-containing gas through the connection pipe 60 gradually decreases. And the dust-containing gas enters the settling chamber 30 from the gas inlet end 31 which is set at the position of the ⅔ height of the total height of the one side of the settling chamber 30. At least a portion of the dust is settled down under the action of inertial force carried by the dust-containing gas after colliding with the baffle plate 32, and is extruded and recycled by entering the collection and extrusion device 50 via the lower end 34 of the settling chamber 30.

Moreover, the dust-containing gas enters the purifying chamber 40 via the gas outlet end 33 that is formed at the gap which is located between the baffle plate 32 and the bottom of the settling chamber 30. Because the cross-section area of the gas outlet end 33 is 2-4 times as large as the cross-section area of the lower end 34 of the settling chamber 30, when the dust-containing gas passes through the filter cylinder assembly 42, the flow velocity of the dust-containing gas decreases dramatically, and at least a portion of the dust is separated from the dust-containing gas and is blocked outside the filter cylinder assembly 42, and a part of the dust directly falls into the collection and extrusion device 50 via the lower end 44 of the settling chamber, while another part of the dust attaches onto the outer wall of the filter cylinder 421. The purified gas is discharged from the outlet 43 of the purifying chamber 40. The electric control system gets the change of the pressure value caused by the dust attached onto the outer wall of the filter cylinder 421 by the pressure sensor, and automatically opens the pulse valve 423. The compressed air contained in the gas tank is discharged from the pulse generator 422 through the pulse valve 423, and is sprayed into the interior of the filter cylinder 421, and a strong impact force generated by the spray flow of the compressed air is used to make the dust attached onto the wall surface of the filter cylinder 421 loose, meanwhile because of a periodic rotation of the pulse generator 422 during a process of spraying thereof, the loose dust falls off and drops into the collection and extrusion device 50 via the lower end 44 of the purifying chamber 40.

Finally, the collection and extrusion device 50 is disposed at the bottom end of the frame 10, and in turn communicated with the lower end 23 of the cyclone device 20, the lower end 34 of the settling chamber 30 and the lower end 44 of the purifying chamber 40 by the housing 51, and collects and recycles the dust which is collected therein. The drive part 52, which is disposed at the end of the housing 51 in its longitudinal direction, drives the blades 511 to rotate. The housing 51 has the conical outlet 512, which is disposed at the other end of the housing 51 in its longitudinal direction, and the cone bottom of the conical outlet 512 is connected to the housing 51. Under the push action when the blades 511 are driven by the drive part 52 to rotate, the dust is constantly accumulated toward the conical outlet 512, and finally is extruded at the outlet 512 and enters the collection part 53 connected to the cone top of the conical outlet 512, so as to accomplish the dust removal.

The method for purifying dust-containing gas with positive pressure in accordance with the embodiments of the disclosure has at least one of the following advantages or a part of one advantage thereof:
(1) the air supply mode with positive pressure is adopted, instead of using the air supply mode with negative pressure, in order to improve the airflow distribution within the dust removal equipment and increase the efficiency of dust removal;
(2) the dust-containing gas passes through the cyclone device, the settling chamber and the purifying chamber in sequence, wherein the dust of the dust-containing gas is sequentially decreased, and the purifying degree of the dust-containing gas is gradually increased;
(3) the tilted deflector plate is disposed at a lower edge of the gas inlet of the cyclone device, and the tilt angle of the tilted deflector plate is the same as the lead angle of helical line of the helical face of the centrifugal cyclone part, so that reentrainment of dust is avoided, and the distribution of the interior airflow becomes more even, which is beneficial for the settling of the dust and lint;
(4) after discharging of the dust-containing gas from the cyclone device, during introducing the dust-containing gas into the settling chamber via the connection pipe, the cross-section area gradually increases, and the flow velocity of the dust-containing gas is reduced, so as to avoid the flow velocity of the dust-containing gas discharged from the cyclone device and entering the settling chamber too large, thereby leading to the flying of the dust and lint;
(5) by setting the gas inlet end at the position of the ⅔ height of the total height of the one side of the settling chamber, and disposing the baffle plate at the opposite side of the gas inlet end, the dust-containing gas collides with the baffle plate after entering the settling chamber, and the airflow direction of the dust-containing gas is abruptly changed, at least a portion of dust is separated from the dust-containing gas under the action of inertial force carried by the dust-containing gas, which partly achieves the function of dust removal;
(6) the dust-containing gas enters the settling chamber from the gas inlet end, the overall flow direction of the dust-containing gas is from top to bottom in the settling chamber, since the gas inlet end is set at the position of the ⅔ height of the total height of the one side of the settling chamber, and the gas outlet end, which is central symmetry with respect to the gas inlet end, is provided between the opposite baffle plate of the settling chamber and the bottom of the settling chamber, wherein the airflow path of the dust-containing gas in the settling chamber is longest, and the settling effect of dust by the gravity is optimal;
(7) the cross-section area of the gas outlet end is 2-4 times as large as the cross-section area of the lower end of the settling chamber, so that the dust-containing gas undergoes reduction of the flow velocity to be settled down after the dust-containing gas entering the purifying chamber, which is beneficial for separating the dust from the dust-containing gas.

The foregoing shows only preferred embodiments of the disclosure, and the scope of the disclosure is not limited to the foregoing embodiments. Without departing apart from the principle and spirit of a general inventive concept of the disclosure, those skilled in the art will understand that the changes can be made to these embodiments and shall be deemed as included in the scope of the disclosure. The scope of the disclosure is defined by the claims and their equivalents.

What is claimed is:

1. A method for purifying dust-containing gas with positive pressure, wherein the method comprises steps as follows:
transporting the dust-containing gas into a cyclone device by the positive pressure;
removing at least a portion of dust from the dust-containing gas by a centrifugal cyclone part of the cyclone device;
entering into a settling chamber, for the dust-containing gas which has been purified in the cyclone device, wherein at least a portion of dust is settled down in the settling chamber with collision under an action of inertial force carried by the dust-containing gas; and
proceeding to enter and purify in a purifying chamber, for the dust-containing gas which has been settled down in the settling chamber, wherein a purified gas flows out from an outlet of the purifying chamber;
the cyclone device, the settling chamber and the purifying chamber are sequentially communicated with each other in series, so as to make the dust-containing gas pass through them in sequence;
a tilted deflector plate is disposed at a gas inlet of the cyclone device, and a tilt angle of the tilted deflector plate is set to be a same as a lead angle of a helical line of a helical face of the centrifugal cyclone part;
a connection pipe is disposed between the cyclone device and the settling chamber, wherein an overall cross-section area of a connecting port of the connection pipe with the cyclone device is in size smaller than an overall cross-section area of a connecting port of the connection pipe with a gas inlet end of the settling chamber;
the gas inlet end communicated with the cyclone device is provided at one side of the settling chamber, wherein the dust-containing gas purified by the cyclone device enters the settling chamber via the gas inlet end, and the gas inlet end is located at a position of a two-thirds height of a total height of the one side of the settling chamber;
a baffle plate is set at an opposite side of the gas inlet end of the settling chamber, a gas outlet end is formed at a gap which is located between the baffle plate and a bottom of the settling chamber, and the settled dust-containing gas in the settling chamber enters the purifying chamber via the gas outlet end to be purified, wherein the gas inlet end is arranged to be central symmetry with respect to the gas outlet end.

2. The method for purifying dust-containing gas with positive pressure in accordance with claim 1, wherein
the dust-containing gas enters the settling chamber via the gas inlet end, and collides with the baffle plate, so that an airflow direction of the dust-containing gas is abruptly changed, and at least a portion of dust is separated from the dust-containing gas under an action of inertial force carried by the dust-containing gas;
a flow velocity of the gas in the settling chamber is 7-12 m/s.

3. The method for purifying dust-containing gas with positive pressure in accordance with claim 1, wherein
a cross-section area of the gas outlet end is set to be 2-4 times as large as a cross-section area of a lower end of the settling chamber, so that the dust-containing gas undergoes reduction of an airflow velocity so as to be settled down after the dust-containing gas enters the purifying chamber; and
a filter cylinder assembly in the purifying chamber is used to filter the dust-containing gas entered therein.

4. The method for purifying dust-containing gas with positive pressure in accordance with claim 1, wherein
the method further comprises:
a step of using a collection and extrusion device arranged at a lower end of at least one of the cyclone device, the settling chamber and the purifying chamber, to extrude and recycle a dust collected therein.

5. The method for purifying dust-containing gas with positive pressure in accordance with claim 4, wherein
a conical outlet is disposed at an end of the collection and extrusion device, wherein the dust which is collected in the collection and extrusion device is extruded by the conical outlet, and the dust is prevented from crossflowing by blades in the collection and extrusion device.

6. The method for purifying dust-containing gas with positive pressure in accordance with claim 1, wherein
a gas inlet direction of the gas inlet is perpendicular to a direction of a rotation axis of the centrifugal cyclone part;
a flow velocity of the gas at the gas inlet is 3-6 m/s.

7. The method for purifying dust-containing gas with positive pressure in accordance with claim 6, wherein
a cross-section area of the connection pipe on a side of the settling chamber is larger than the cross-section area of the connection pipe on a side of the cyclone device.
